(19) United States
(12) Patent Application Publication
(10) Pub. No.: US 2009/0265022 A1
(43) Pub. Date: Oct. 22, 2009

(54) PLAYBACK OF MULTIMEDIA DURING MULTI-WAY COMMUNICATIONS

(75) Inventors: Darko Kirovski, Kirkland, WA (US); Ydo Wexler, Seattle, WA (US); Christopher A. Meek, Kirkland, WA (US)

Correspondence Address: Microsoft Corporation;Patent Group Docketing Dept., One Microsoft Way, Redmond, WA, 98052, US

(73) Assignee: Microsoft Corporation, Redmond, WA (US)

(21) Appl. No.: 12/144,673

(22) Filed: Jun. 24, 2008

Related U.S. Application Data
(60) Provisional application No. 61/046,698, filed on Apr. 21, 2008.

(51) Int. Cl. G06F 17/00; G10L 13/00; H04M 1/00

(52) U.S. Cl. 700/94; 704/260; 455/556.1; 704/E13.001

(57) ABSTRACT

Multimedia playback technique embodiments are presented which facilitate the playback of an arbitrary media recording during a multi-party communication over a real-time multi-way communication system via a user's communication device. The recorded media can be interjected into a multi-party communication on a real time basis. This is generally accomplished by the media recording being inserted into a media stream being processed by the user's communication device as part of the multi-party communication. This can be done by either replacing a portion of the media stream with the media recording or mixing the media recording with a portion of the media stream. Once inserted, the media recording is transmitted as part of the media stream to a least one other party to the communication.

### CROSS REFERENCE TO RELATED APPLICATION

This application claims the benefit of and priority to provisional U.S. patent application Ser. No. 61/046,698, filed Apr. 21, 2008.

### BACKGROUND

Multi-way communications such as a traditional telephone conversation, or more recently, a mobile telephone conversation, are by their nature real time communications. As such, the participants have to generate their communication content in real-time. The same can be said for current IP telephony which allows a user to participate in multi-way communications over a computer network, such as the Internet.

### SUMMARY

The multimedia playback technique embodiments described herein facilitate the playback of an arbitrary media recording during a multi-party communication over a real-time multi-way communication system via a user's communication device. Thus, recorded media can be interjected into a multi-party communication on a real time basis. This is generally accomplished by a computing device associated with the user's communication device inputting a user command to initiate the playback of a media recording. In response, the media recording is inserted into a media stream being processed by the user's communication device as part of the multi-party communication. This is done by either replacing a portion of the media stream with the media recording or mixing the media recording with a portion of the media stream. Once inserted, the media recording is transmitted as part of the media stream to at least one other party to the communication. Examples of the aforementioned media are audio-visual (A/V) media, video-only media, and audio-only media.

It should be noted that this Summary is provided to introduce a selection of concepts, in a simplified form, that are further described below in the Detailed Description. This Summary is not intended to identify key features or essential features, nor is it intended to be used as an aid in determining the scope of the claimed subject matter.

### DESCRIPTION OF THE DRAWINGS

The specific features, aspects, and advantages of the disclosure will become better understood with regard to the following description, and accompanying drawings where:

FIG. 1 is a simplified architectural diagram depicting an exemplary multi-way communication system in which portions of the multi-media playback technique embodiments described herein may be implemented.

FIG. 2 is a flow diagram generally outlining one embodiment of a process for playing back an audio recording during a multi-party communication over a real-time multi-way communication system via a user's communication device, where the audio recording replaces a portion of the audio stream.

FIG. 3 is a flow diagram generally outlining one embodiment of a process for playing back an audio recording during a multi-party communication over a real-time multi-way communication system via a user's communication device, where the audio recording is mixed into a portion of the audio stream.

FIG. 4 is a flow diagram generally outlining one embodiment of a process for employing the exemplary multi-way communication system of FIG. 1 to play back an audio recording during a multi-party communication, where the audio recording replaces a portion of the audio stream.

FIG. 5 is a flow diagram generally outlining one embodiment of a process for employing the exemplary multi-way communication system of FIG. 1 to play back an audio recording during a multi-party communication, where the audio recording is pre-encoded and packetized, and replaces an encoded and packetized portion of the audio stream.

FIG. 6 is a flow diagram generally outlining one embodiment of a process for employing the exemplary multi-way communication system of FIG. 1 to play back an audio recording during a multi-party communication, where the audio recording is mixed with a portion of the audio stream.

FIG. 7 is a flow diagram generally outlining one embodiment of a process for employing the exemplary multi-way communication system of FIG. 1 to play back an audio recording during a multi-party communication, where the audio recording is an altered version of a portion of the audio stream.

### DETAILED DESCRIPTION

In the following description of multi-media playback technique embodiments reference is made to the accompanying drawings which form a part hereof, and in which are shown, by way of illustration, specific embodiments in which the technique may be practiced. It is understood that other embodiments may be utilized and structural changes may be made without departing from the scope of the technique.

### 1.0 Multi-Media Playback

The multi-media playback technique embodiments described herein generally allow any party to a communication over a real-time multi-way communication system to mix or augment the real-time multimedia stream with pre-recorded and/or generated multimedia. More particularly, in one embodiment, a user who participates in a communication with at least one other user, would at a desired moment during their conversation use a simple user interface (UI) to either mix with or replace his/her live, real-time multi-media signal with an arbitrary recording stored on or generated by his/her communication device. For example, following telling a joke in the conversation, the user can cause pre-recorded applause or laughter to be played over the audio channel. Another example would be a user interjecting a famous quote from a movie, TV show, or the news into the conversation. Or in response to a disagreement as to what was said previously in the conversation or in a prior conversation, playback a recording of the earlier discussion to resolve the issue.

The following sections will describe various multi-media playback technique embodiments in more detail. It is noted that while any media can be involved (e.g., A/V, video-only, audio-only), the following sections will use an audio-only implementation as an example. It is in no way intended by this use of an audio-only example to limit the scope of the invention to just that implementation. Rather, any media can be employed and is within the scope of the invention.

### 1.1 Multi-Way Communication System Environment

Before the multi-media playback technique embodiments are described, an exemplary description of a suitable multi-way communication system environment in which portions thereof may be implemented will be described.

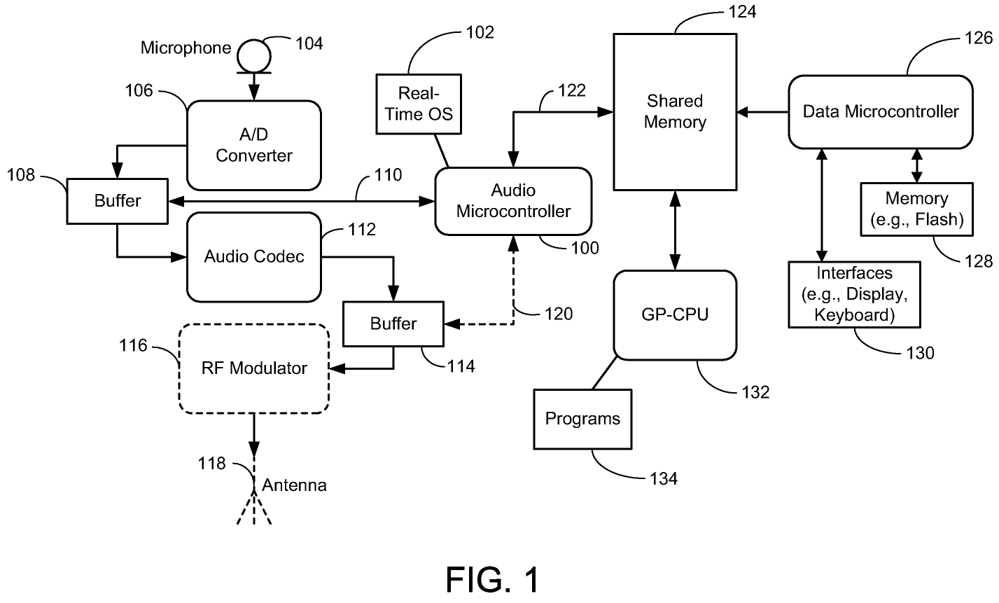

Referring to FIG. 1, the audio path is controlled by an audio microcontroller 100. The audio microcontroller runs a real-time operating system (OS) 102 and controls all aspects of audio transfer from acquisition, through coding, error correction, packetizing, and possible RF modulation. More particularly, audio (e.g., a user's voice) is captured by a microphone 104, which generates an analog audio signal that is fed into an A/D converter module 106, which digitizes the signal. The digitized audio signal is then temporarily queued in a first buffer 108. There is a direct access 110 between the audio microcontroller 100 and the first buffer 108, by which the audio microcontroller can pull-out or insert digitized audio data from/to the first buffer. At the instruction of the microcontroller 100, digitized audio data queued in the first buffer 108 is fed into an audio codec module 112. The audio codec module 112 is responsible for at least one of encoding, encrypting, and adding error correction data to the digitized audio data. The audio codec module 112 also packetizes the resulting data. It is noted that in many multi-way communication systems the audio codec is optimized for audio in the frequency range of the human voice. While this is acceptable for many embodiments of the multi-media playback technique described herein, a codec optimized for a broader audio frequency range would be advantageous in other embodiments, such as when music is involved.

The packetized data is next sent to the second buffer 114, where it is queued for output to the other parties in the multi-way communication. In a wireless mobile telephone system, the packetized data is held in the second buffer 114 until a time-multiplexed frame becomes available at which time it would be modulated in an RF modulator module 116 and broadcast via an antenna 118. The RF modulator module 116 and antenna 118 are shown as broken line boxes to indicate they are included in a wireless mobile telephone system, but may not be necessary in other multi-way communication systems (e.g., IP telephone). It is also noted that there is an optional direct access 120 between the audio microcontroller 100 and the second buffer 108, by which the audio microcontroller can pull-out or insert packetized audio data from/to the second buffer. The optional nature of this connection is indicated by the dashed line in FIG. 1. The foregoing part of the multi-way communication system environment deals with the dissemination of audio and as such is a real-time system. However, other aspects of the environment need not be operated in a real-time fashion. These will be described next.

The audio microcontroller 100 also has access 122 to a shared memory 124. The audio microcontroller 100 can place data in the shared memory 124 and use data stored in the shared memory 124. A data access microcontroller 126 also has access to the shared memory 124. This data access microcontroller also has access to a separate memory 128, such as a flash memory or the like, and is in communication with one or more user interfaces, such as a display and keyboard, via an interface module 130. The data access microcontroller 126, memory 128 and interface module 130 provide a data path to input commands from the user (e.g., telephone numbers, URLs), and to display non-audio data to the user. A general purpose central processing unit (GP-CPU) 132 is also connected to the shared memory 124. The GP-CPU 132 executes programs resident in the programs module 134, such as a Web browser and other applications (e.g., games, messaging, e-mail, and so on) and can receive/send user interface data via the shared memory 124 and the aforementioned data path.

It is noted that the multi-media playback technique embodiments described herein may be described in the general context of computer-executable instructions, such as program modules, being executed by a computing device. Generally, program modules include routines, programs, objects, components, data structures, etc. that perform particular tasks or implement particular abstract data types. In the context of the exemplary multi-way communication system environment, the program modules associated with actions taken by the audio microcontroller 100 reside in the real time OS 102, and the program modules associated with actions taken by the GP-CPU 132 reside in the programs module 134.

Examples of a real-time multi-way communication system exhibiting the above-described characteristics include wireless mobile telephones, IP telephones, and other real-time communication devices.

### 1.2 Audio Recording Playback

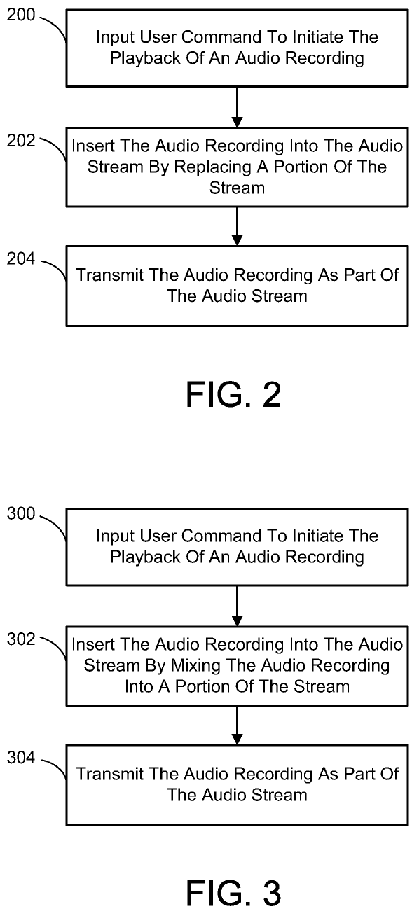

Given a suitable multi-way communication system environment such as the exemplary environment described in the previous section, in one embodiment, playing back an arbitrary audio recording during a multi-party communication via a user's communication device can generally be accomplished using the following technique. Referring to FIG. 2, a user command is input to initiate the playback of an audio recording, as shown in block 200. The audio recording is then inserted into an audio stream being processed by the user's communication device as part of the communication by replacing a portion of the audio stream, as shown in block 202. The audio recording is then transmitted, as part of the audio stream, to a least one other party to the communication, as shown in block 204.

It is noted that in the foregoing embodiment, the audio recording replaces a portion of the audio stream. In another embodiment, the audio recording is mixed into a portion of the audio stream. More particularly, referring to FIG. 3, a user command is input to initiate the playback of an audio recording, as shown in block 300. The audio recording is then inserted into an audio stream being processed by the user's communication device as part of the communication by mixing the audio recording into a portion of the audio stream, as shown in block 302. The audio recording is then transmitted, as part of the audio stream, to a least one other party to the communication, as shown in block 304.

As indicated above, during a conversation, a user involved in a multi-way communication initiates the playback of an arbitrary audio recording (hereinafter also referred to as an audio clip) by inputting a command into the communication device. This audio clip may be stored on or generated by the user's communication device. The user initiation can take any appropriate form. For example, in one embodiment, the user can enter a code corresponding to the desired audio clip by pressing a key or a combination of keys on a keyboard of the communication device. If there are multiple audio clips available, a different key or combination of keys can be used to access the different clips. Alternately, the user can select the desired clip from a list displayed on the display of his or her communication device.

In regard to the alternative embodiment of the technique where the clip is generated, this can also take any appropriate form, such as, in one implementation, the use of a text-to-speech technique to convert text stored in the communication device or entered by the user, into an audio clip. It is noted that in one implementation, the aforementioned GP-CPU is responsible for generating the audio clip, which is then placed in the shared memory.

In regard to the alternative where the audio clip is stored on the user's communication device rather than generated, in one implementation, the audio clip is stored on the aforementioned separate memory associated with the data access microcomputer. Under this scenario, the GP-CPU requests that the data access microcomputer access the stored clip in the separate memory and place a copy in the shared memory. This request can be done via the shared memory, or directly if possible.

As stated previously, the audio clip can be mixed into the conversation taking place and then played back, or simply played back in lieu of the conversation. If both alternatives are available, the user can specify which is to take place when initiating the playback of the audio clip.

Implementations of the foregoing general audio recording playback technique by replacing a portion of the audio stream with an audio clip or mixing the stream with the clip will now be described in the sections to follow.

### 1.2.1 Audio Recording Playback by Replacing a Portion of the Audio Stream

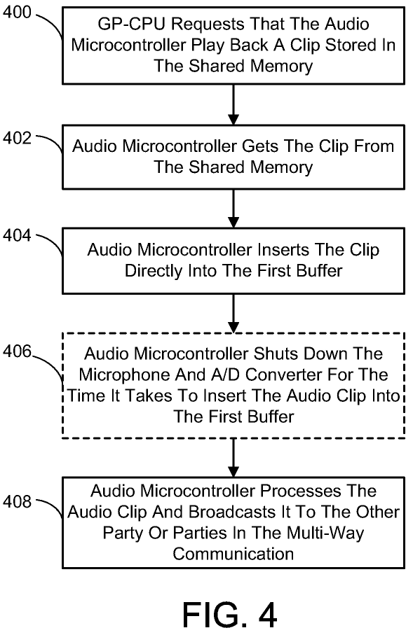

In the embodiments where the audio clip replaces a portion of the conversation, in one implementation shown in FIG. 4, the GP-CPU requests that the aforementioned audio microcontroller play back the clip stored in the shared memory (block 400). This request can be performed via the shared memory, or directly if possible. The audio microcontroller gets the clip from the shared memory (block 402) and inserts it directly into the first buffer (block 404), temporarily supplanting the output from the aforementioned A/D converter. It is noted that the microphone and A/D converter can be shut down by the audio microcontroller for the time it takes to insert the audio clip to prevent interference and save power (optional block 406 shown in dashed lines). The audio clip is then processed as described previously and broadcast to the other party or parties in the multi-way communication (block 408).

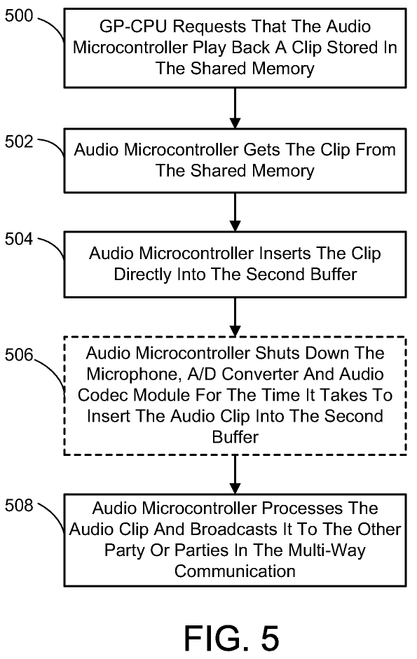

In an alternate implementation of the embodiment where the audio clip replaces a portion of the conversation shown in FIG. 5, the GP-CPU once again requests that the aforementioned audio microcontroller play back the clip stored in the shared memory (block 500). However, the stored clip has a different format than other implementations where the clip is digitized audio data. Instead the stored clip is pre-encoded and packetized in the same manner as is done by the aforementioned audio codec module. This allows the clip to be inserted into the aforementioned second buffer as will be described shortly. It is noted that the clip can be encoded and packetized by the GP-CPU and then placed in the shared storage before the audio controller is requested to insert it into the audio stream. However, the audio clip can also be loaded into the separate memory in a pre-encoded and packetized form, such that no additional processing by the GP-CPU is required. Either way, the audio microcontroller gets the clip from the shared memory (block 502). In this implementation, the audio clip is inserted directly into the second buffer (block 504), where it temporarily supplants the output from the audio codec module. It is noted that the microphone, A/D converter, and audio codec module can be shut down by the audio microcontroller for the time it takes to insert the audio clip to prevent interference and save power (optional block 506 shown in dashed lines). The audio clip is then processed as described previously and transmitted to the other party or parties in the multi-way communication (block 508).

An interesting application of the foregoing replacement scenario entails first processing the recorded audio clip to add background noise consistent with the on-going communication. This makes the clip sound more authentic and a natural part of the conversation when played back. The noise background can be estimated and synthesized from a sampling of the communication or similar communications, or it can be the actual background noise derived from the communication. The noise background is mixed with the user selected audio clip by the GP-CPU and placed in the shared memory prior to the request being made to insert it into the audio stream of the communication. The GP-CPU accesses a portion of the audio stream to generate the background noise in the same manner as will be described in the next section.

1.2.2 Audio Recording Playback by Mixing the Clip with a Portion of the Audio Stream

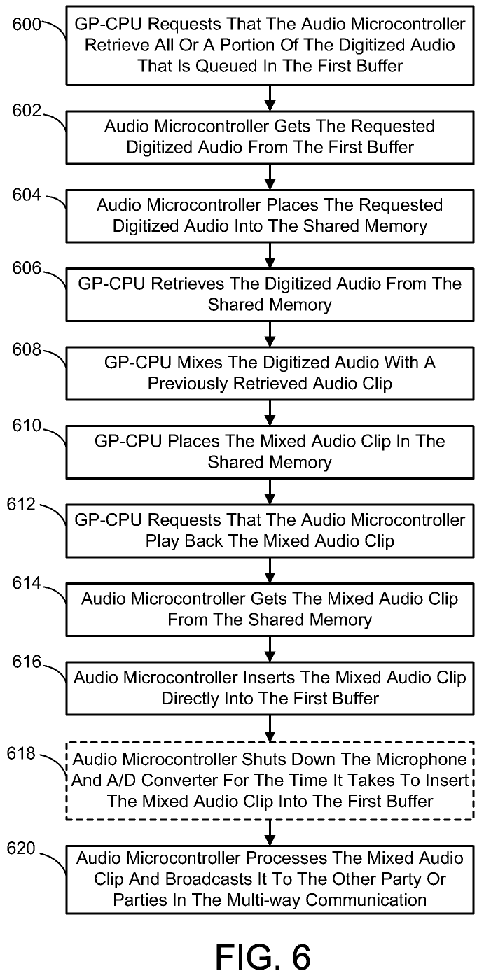

In the embodiments where the audio clip is mixed with a portion of the conversation audio stream, in one implementation as shown in FIG. 6, the GP-CPU requests that the aforementioned audio microcontroller retrieve all or a portion of the digitized audio that is queued in the aforementioned first buffer (block 600). This request can be done via the shared memory, or directly if possible. The audio microcontroller gets the requested digitized audio from the first buffer (block 602) and places it in the shared memory (block 604). The GP-CPU then retrieves the digitized audio from the shared memory (block 606) and mixes it with a previously retrieved audio clip (block 608). The now mixed audio clip is then placed in the shared memory (block 610), and the GP-CPU requests that the audio microcontroller play back the mixed clip (block 612). The audio microcontroller retrieves the mixed clip from the shared memory (block 614) and inserts it directly into the first buffer (block 616). It is noted that the entire mixing procedure can be accomplished and the mixed clip placed in the first buffer in the time the digitized audio would have been queued. Therefore, the mixing is in effect done on a real time basis. It is also noted that the microphone and A/D converter can be shut down by the audio microcontroller for the time it takes to insert the mixed audio clip into the first buffer to prevent interference and save power (optional block 618 shown in dashed lines). The mixed clip is then processed as described previously and transmitted to the other party or parties in the multi-way communication (block 620).

One interesting application of the foregoing mixing scenario entails the audio clip being a musical piece, such that a musical background is added to the user's words when the conversation audio stream is mixed with the clip. In this way, a musical-style conversation can be created. Further, the words to a song can be displayed on the display of the user's communication device, and when read by the user mixed with the music associated with the song to create a Karaoke-like experience for the parties to the communication.

1.2.3 Audio Playback by Replacing a Portion of the Audio Stream with an Altered Version Thereof

In another embodiment of the multi-media playback technique, an altered version of the communication's audio stream becomes the audio clip that is inserted.

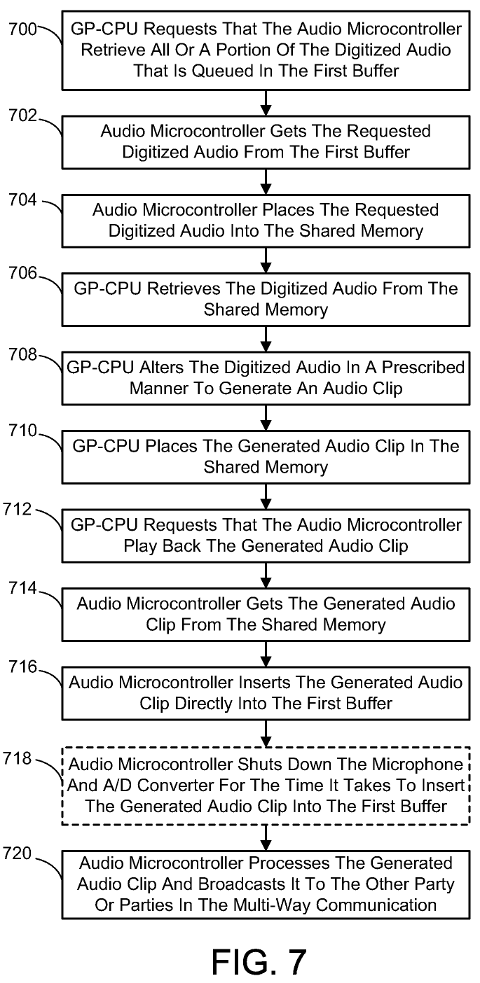

More particularly, in one implementation as shown in FIG. 7, the GP-CPU requests that the aforementioned audio microcontroller retrieve all or a portion of the digitized audio that is queued in the aforementioned first buffer (block 700). This request can be done via the shared memory, or directly if possible. The audio microcontroller gets the requested digitized audio from the first buffer (block 702) and places it in the shared memory (block 704). The GP-CPU then retrieves the digitized audio from the shared memory (block 706) and alters it in a prescribed manner to generate an audio clip (block 708). For example, the user's voice can be disguised, or enhanced, or changed in some desired way. The generated audio clip is then placed in the shared memory (block 710), and the GP-CPU requests that the audio microcontroller playback the clip (block 712). The audio microcontroller retrieves the generated clip from the shared memory (block 714) and inserts it directly into the first buffer (block 716). It is noted that the entire altering procedure can be accomplished and the generated clip placed in the first buffer in the time the digitized audio would have been queued. Therefore, the altering is in effect done on a real time basis. It is also noted that the microphone and A/D converter can be shut down by the audio microcontroller for the time it takes to insert the generated audio clip into the first buffer to prevent interference and save power (optional block 718 shown in dashed lines). The generated clip is then processed as described previously and transmitted to the other party or parties in the multi-way communication (block 720).

### 2.0 Obtaining Audio Clips

The above-described recorded audio clips can be obtained in a variety of ways. For example, they can be obtained in a manner similar to cell phone ring tones. For instance, a business can provide the audio clips on a subscription basis that provides the clips for a limited time for a periodic (e.g., monthly) fee. The clips can also be purchased for unlimited playback, or on a pay-per-play basis, or provided as part of an advertising scheme. The clips once obtained can be loaded into the aforementioned separate memory in any appropriated manner, similar to the way ring tones are loaded into a cell phone.

The clips can also be pre-loaded into the user's communication device, in much the same way cell phones come with a variety of ring tones already resident when the phone is purchased. This pre-loading feature can be used to create a line of theme devices, where the user's communication device is pre-loaded with multimedia from a specific movie, television show, musical group, and so on.

It is noted that an arbitrary digital right management (DRM) program executed by the aforementioned GP-CPU can be included on a user's communication device. This DRM handles licenses and access control for playback of recorded multimedia for any of the foregoing methods of obtaining clips.

A viral incentive-based marketing scheme can also be employed to offer clips to a user. In this scheme, the recipient of a recorded clip sent by another party is offered the same or another clip for purchase. In this clip acquisition scenario, the sender might receive an incentive for providing the clip. Another way clips can be offered for sale is via a recommendation based advertising scheme. This entails offering additional clips to a user based on, although not limited to, the clips played by the user or other parties to a conversation with the user. This can be expanded to include the offer of non-clip goods and services as well.

In another embodiment, the service provider could set up auction-based bidding for playing multimedia X related to playing a specific multimedia clip Y during a conversation between A and B. The advertisement for X could be a text, visual message displayed on A's or B's communication device. It might even be audio, although this method might interrupt the conversation between A and B. The copyright behind clip Y could be presented as free to A and B as the advertiser would pick up the tab.

### 3.0 Other Embodiments

In the foregoing description of embodiments for the multi-media playback technique, the focus was on the playback of recorded or generated audio clips. No mention was made as to what could be done by the recipient of an audio clip. In one alternate embodiment, the audio clips contain additional data incorporated into the clip using watermarking methods. This additional data can be extracted by the recipient's communication device. Thus, data other than audio can be included in a clip and sent to another party in the communication. In this way a separate channel of communication can be established with a recipient's communication device. The type of data can include emotional state indicators, pointers to websites, advertisements, other data, and so on.

The recipient could also use an audio fingerprinting technique to identify clips played on the communication channel. An audio fingerprint is a compact content-based signature that summarizes an audio recording. Audio fingerprinting technologies have attracted attention since they allow the identification of audio independently of its format and without the need of meta-data or watermark embedding. In order to identify audio fingerprints, the recipient needs to be connected to a database server which provides positive matches.

It is also noted that while the foregoing description of embodiments for the multi-media playback technique focused on the playback of recorded or generated audio clips, other forms of recorded or generated clips can also be played back over the communication channel. For example, if the communication channel allows for the transmission of video, the recorded or generated clips could be video-only clips or audio-video (A/V) clips.

Finally, it is noted that any or all of the aforementioned embodiments throughout the description may be used in any combination desired to form additional hybrid embodiments.

Wherefore, what is claimed is:

1. A computer-implemented process for playing back an arbitrary media recording during a multi-party communication over a real-time multi-way multi-media communication system via a user's communication device, the process comprising using a computer to perform the following process actions:
inputting a user command to initiate the playback of a media recording;
inserting the media recording into a media stream being processed by the user's communication device as part of the communication by replacing a portion of the media stream; and
transmitting the media recording as part of the media stream to a least one other party to the communication.

2. The process of claim 1, further comprising an action of generating the media recording prior to inserting it into the media stream.

3. The process of claim 2, wherein the media is audio, and wherein the process action of generating the media recording, comprises an action of generating an audio recording from text using a text-to-speech converter, wherein said text is stored in a storage medium associated with the user's communication device or entered into the user's communication device by the user.

4. The process of claim 1, further comprising an action of retrieving the media recording from a storage medium prior to inserting it into the media stream.

5. The process of claim 1, wherein the user's communication device is a wireless mobile telephone.

6. The process of claim 1, wherein the user's communication device is an Internet Protocol (IP) telephone.

7. The process of claim 1, wherein the media is at least one of video and audio.

8. A computer-implemented process for playing back an arbitrary media recording during a multi-party communication over a real-time multi-way multi-media communication system via a user's communication device, the process comprising using a computer to perform the following process actions:
inputting a user command to initiate the playback of a media recording;
inserting the media recording into a media stream being processed by the user's communication device as part of the communication by mixing the media recording into a portion of the media stream; and
transmitting the media recording as part of the media stream to a least one other party to the communication.

9. The process of claim 8, wherein the media is at least one of video and audio.

10. A communication device for playing back an arbitrary audio clip during a multi-party communication over a real-time multi-way communication system, comprising:
an audio microcontroller which controls various aspects of audio transfer comprising,
acquisition of a user's voice and other sounds via a microphone and a subsequent conversion of a signal output by the microphone to a digital audio signal via an analog-to-digital (A/D) converter,
temporarily queuing of the digital audio signal in a first buffer connected to the converter, wherein the audio microcontroller has direct access to the first buffer through which additional digitized audio data is inserted into the digital audio signal by the audio microcontroller via the first buffer,
encoding of the digital audio signal after leaving the first buffer via an audio codec module, wherein the audio microcontroller dictates when portions of the digital audio signal queued in the first buffer are fed into the audio codec module, and wherein said encoding comprises at least one of encoding, encrypting, and adding error correction data to the digital audio signal, followed by packetizing the resulting signal to produce an encoded audio signal,
temporarily queuing of the encoded audio signal in a second buffer connected to the audio codec module, and
outputting the encoded audio signal to at least one other party in the multi-party communication;
a shared memory to which the audio microcontroller has access and from which the audio microcontroller can copy digitized audio data for insertion into the first buffer; and
a general purpose central processing unit (GP-CPU) which has access to the shared memory.

11. The communication device of claim 10, wherein the audio microcontroller further controls a replacement of a portion of the audio signal with said audio clip, wherein said replacement comprises the audio microcontroller:
receiving a request from the GP-CPU to playback an audio clip stored in the shared memory;
retrieving the requested audio clip from the shared memory;
inserting the requested audio clip directly into the first buffer, thereby temporarily supplanting the output from the A/D converter; and
causing the audio clip to be encoded by the audio codec module, temporarily queued in the second buffer, and output to at least one other party in the multi-party communication.

12. The communication device of claim 11, wherein said replacement further comprises the audio microcontroller shutting down the microphone and A/D converter for the time it takes to insert the requested audio clip into the first buffer in order to prevent interference and save power.

13. The communication device of claim 10, wherein the audio microcontroller has direct access to the second buffer through which additional encoded audio data is inserted into the digital audio signal by the audio microcontroller via the second buffer, and wherein the audio microcontroller further controls a replacement of a portion of the audio signal with said audio clip, wherein said replacement comprises the audio microcontroller:
receiving a request from the GP-CPU to playback an audio clip stored in the shared memory;
retrieving the requested audio clip from the shared memory, wherein said audio clip is pre-encoded and packetized in the same manner as is accomplished by the audio codec module;
inserting the requested audio clip directly into the second buffer, thereby temporarily supplanting the output from the audio codec module; and
causing the audio clip to be temporarily queued in the second buffer, and output to at least one other party in the multi-party communication.

14. The communication device of claim 13, wherein said replacement further comprises the audio microcontroller shutting down the microphone, A/D converter and audio codec module for the time it takes to insert the requested audio clip into the second buffer in order to prevent interference and save power.

15. The communication device of claim 10, wherein said audio clip is stored in the shared memory, the audio microcontroller is capable of placing data in the shared memory, and wherein the audio microcontroller and GP-CPU further control a mixing of the audio clip with a portion of the audio signal, wherein said mixing comprises:
the GP-CPU requesting that the audio microcontroller retrieve all or a portion of the audio signal that is queued in the first buffer;
the audio microcontroller receiving the request from the GP-CPU, retrieving the queued audio signal from the first buffer and placing it in the shared memory;
the GP-CPU retrieving the queued audio signal, along with the audio clip, from the shared memory;
the GP-CPU mixing of the audio clip with the queued audio signal, placing the mixed audio clip into the shared memory, and requesting the audio microcontroller to playback the mixed audio clip;
the audio microcontroller retrieving the mixed audio clip from the shared memory and inserting it directly into the first buffer, thereby temporarily supplanting the output from the A/D converter; and
the audio microcontroller causing the mixed audio clip to be encoded by the audio codec module, temporarily queued in the second buffer, and output to at least one other party in the multi-party communication.

16. The communication device of claim 15, wherein said mixing further comprises the audio microcontroller shutting down the microphone and A/D converter for the time it takes to insert the mixed audio clip into the first buffer in order to prevent interference and save power.

17. The communication device of claim 15, wherein the said audio clip is music.

18. The communication device of claim 17, further comprising a display, and wherein words intended to accompany the music of the audio clip are displayed to the user who reads them, such when the audio signal associated with the user's words is mixed with the music of the audio clip it appears to the at least one other party in the multi-party communication that the user is singing a song.

19. The communication device of claim 10, wherein the audio microcontroller is capable of placing data in the shared memory, and wherein the audio microcontroller and GP-CPU further control an altering of the audio signal, wherein said altering comprises:
the GP-CPU requesting that the audio microcontroller retrieve all or a portion of the audio signal that is queued in the first buffer;
the audio microcontroller receiving the request from the GP-CPU, retrieving the queued audio signal from the first buffer and placing it in the shared memory;
the GP-CPU retrieving the queued audio signal from the shared memory, altering it in a prescribed manner to produced an altered portion of the audio signal, placing the altered portion of the audio signal into the shared memory, and requesting the audio microcontroller to playback the altered portion of the audio signal;
the audio microcontroller retrieving the altered portion of the audio signal from the shared memory and inserting it directly into the first buffer, thereby temporarily supplanting the output from the A/D converter; and
the audio microcontroller causing the altered portion of the audio signal to be encoded by the audio codec module, temporarily queued in the second buffer, and output to at least one other party in the multi-party communication.

20. The communication device of claim 10, wherein said audio clip is stored in the shared memory along with a background noise audio signal and wherein the audio microcontroller and GP-CPU further control a mixing of the audio clip with the background noise audio signal, wherein said mixing comprises:
the GP-CPU retrieving the background noise audio signal, along with the audio clip, from the shared memory;
the GP-CPU mixing of the audio clip with the background noise audio signal, placing the mixed audio clip into the shared memory, and requesting the audio microcontroller to playback the mixed audio clip;
the audio microcontroller retrieving the mixed audio clip from the shared memory and inserting it directly into the first buffer, thereby temporarily supplanting the output from the A/D converter; and
the audio microcontroller causing the mixed audio clip to be encoded by the audio codec module, temporarily queued in the second buffer, and output to at least one other party in the multi-party communication.
